(19) United States
(12) Patent Application Publication
(10) Pub. No.: US 2005/0194178 A1
(43) Pub. Date: Sep. 8, 2005

(54) Hybrid superconducting cable for power transmission

(76) Inventors: Ying Xin, Beijing (CN); Yong Zhang, Beijing (CN); Weizhi Gong, Beijing (CN)

Correspondence Address: WESTMAN CHAMPLIN & KELLY, P.A., SUITE 1400 - INTERNATIONAL CENTRE, 900 SECOND AVENUE SOUTH, MINNEAPOLIS, MN, 55402-3319, US

(21) Appl. No.: 11/032,607

(22) Filed: Jan. 10, 2005

(30) Foreign Application Priority Data
Mar. 5, 2004 (CN) 2004100074980

(51) Int. Cl. H01B 12/00

(52) U.S. Cl. 174/125.1

(57) ABSTRACT

A superconducting cable with hybrid conductor unit is provided, which includes a cable former, a conductor unit, an adiabatic envelope, a dielectric layer, screening layer and protective encloser characterized in that the hybrid conductor unit is formed from a combination of superconductor layers, normal metal conductor layers, and superconductor-normal metal mixed layers. As compared with a typical superconductor cable having the same power transmission capacity, the hybrid superconductor cable has the following advantages: simplify the fabrication process; reduce the manufacturing cost; enhance the cable's mechanical strength and increase the cable's ability to withstand over flow current and quench. The hybrid superconductor cable lays the foundation for superconductor cable's industrialization.

### BACKGROUND OF THE INVENTION

1. Field of the Invention

The present invention generally relates to a superconductor cable for power transmission, and more specifically to a hybrid superconductor cable.

2. Description of the Background Art

Currently, almost all the superconducting cables fabricated around the world are winded using solely superconductor tape. For example, 30 m 3 phase 12.5 kV/1250 A CD superconductor cable made by Southwire company of United States, 30 m 30 kV/2 kA WD superconductor cable made by NKT, Danmark, 100 m 3 phase 66 kV/1 kA three parallel-axes cores superconductor cable made by Sumitomo Electric Industries and Tokyo Electric Power Company, Japan. The conductors of all these cables were made of several layers of pure superconductor tapes. This kind of superconductor cables has some disadvantages proven by numerous experiments and studies. For example, it is difficult to make full use of power transmission capacity of the superconductors, the fabrication cost is high, the mechanical strength is low, and the capability of withstanding quench is insufficient. These problems affect the development and application of superconductor cables.

### SUMMARY OF THE INVENTION

The present invention has been made to solve the above problems, and it is an object of the present invention to provide a hybrid superconductor cable, in which normal metal tapes are employed to partially substitute superconductor tapes for saving superconductor tapes and reducing the cost. As compared with the conventional superconductor cables, with the same current carrying capacity, the hybrid superconductor cable not only has lower cost and simpler fabrication technology, but also has enhanced mechanical strength and the ability to resist quench. Thus it is more suitable for industrialization.

In accordance with the present invention, the above objects can be accomplished by the provision of a hybrid superconductor cable, which includes cable former, a conductor unit, an adiabatic envelope, a screening layer and a protective encloser. The conductor unit mentioned is a hybrid conductor unit formed from mixed conductors or a combination of superconductor layers, normal metal conductor layers and/or mixed conductor layers.

Wherein, the hybrid superconducting cable further comprises a dielectric layer.

According to current carrying capacity, the pattern by which the layers in the hybrid conductor unit are combined can be selected from a group consisting of the followings:
A. all the layers are mixed conductor unit;
B. the layers are combination of superconductor unit and normal metal conductor unit;
C. the layers are combination of superconductor unit and mixed conductor unit;
D. the layers are combination of normal metal conductor unit and mixed conductor unit; and
E. the layers are combination of superconductor unit, normal metal conductor unit and mixed conductor unit.

The mixed conductor layers mentioned above are made of superconductor tapes and normal metal tapes by alternate arranging and winding.

The numbers of the superconductor layers, the normal metal conductor layers and the mixed conductor layers are respectively in the range of 1 to 20.

The cross-sectional shapes of the superconductor tapes and the normal metal tapes are rectangle, square, circle, ellipse or flat ellipse.

The material of the normal metal tapes is selected from a group consisting of copper, aluminum, silver and their alloy.

As compared with conventional superconductor cables, with the same current carrying capacity, the hybrid superconductor cable according to the present invention has advantages lied in not only lower cost and simpler fabrication technology, but also has enhanced the mechanical robustness and the ability to resist quench. Therefore, it is more suitable for industrialization.

### BRIEF DESCRIPTION OF DRAWINGS

The forgoing and other objects and features of the present invention will be more clearly understood from the following detailed description taken in conjunction with the accompanying drawings, in which:

FIG. 1 is a perspective schematic view of a hybrid superconductor cable in according with an embodiment of the present invention showing out multilayer structure thereof.

FIG. 2 is a perspective schematic view of a hybrid superconductor cable in according with the present invention with a conductor unit formed completely from mixed conductor layers.

FIG. 3 is a schematic view of an embodiment of the hybrid superconductor cable in according with the present invention showing out the multilayer structure thereof.

FIG. 4 is a schematic view of another embodiment of the hybrid superconductor cable in according with the present invention showing out the multilayer thereof.

FIG. 5 shows cross-section views of the superconductor tapes and normal conductor tapes;

FIG. 6 is a perspective schematic view of a hybrid superconductor cable in according with another embodiment of the present invention showing out multilayer structure thereof.

### DETAILED DESCRIPTION OF THE INVENTION

Reference will now be made in detail to the preferred embodiments of the present invention, examples of which are illustrated in the accompanying drawings.

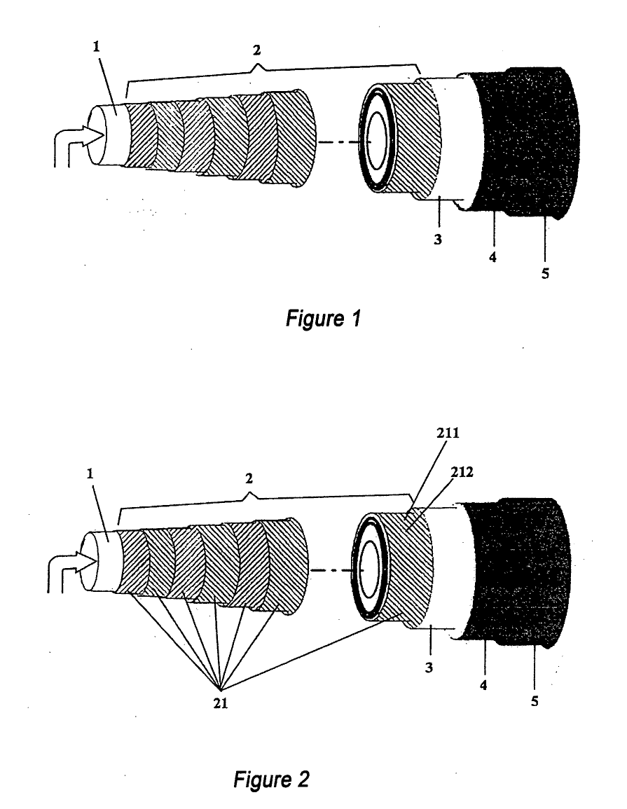

FIG. 1 is a perspective schematic view of a hybrid superconductor cable in according with an embodiment of the present invention showing out multilayer structure thereof. As shown in FIG. 1, the cable includes a cable former 1, a conductor unit 2, an adiabatic envelope 3, a screening layer 4 and a protective encloser 5. The conductor unit 2 is a hybrid conductor unit which is formed from mixed conductor layers 21 (ref. FIG. 2) or a combination of the mixed layers 21, superconductor layers 22, and normal metal conductor layers 23. The concept and principle of the mixed conductor layer 21, the superconductor layer 22 and the normal metal conductor layer 23 are described as followed.

In order to take full advantage of the current carrying capacity of superconductors and reduce the manufacturing costs of superconducting cable, the conductor unit is combined by a principle. That is the layers loading large currents employ superconductor materials and are called superconductor layers 22, the layers loading small currents employ normal metal conductor materials and are called normal conductor layers 23 and, the layers loading moderate currents employ the superconductor tapes and normal metal conductors tapes arranged and winded alternately and are called as mixed conductor layers 21. The conductor tapes used in the same layer have the same cross sectional size and shape, including superconductor tapes and the normal metal tapes, while tapes in different layer are not necessary to have the same size and shape.

The hybrid conductor unit 2 mentioned above has several possible combination patterns, according to the designed power transmission capacity, which are
A. all the layers are mixed conductor layer 21;
B. the layers are combination of superconductor layers 22 and normal metal conductor layers 23;
C. the layers are combination of superconductor layers 22 and mixed conductor layers 21;
D. The layers are combination of normal metal conductor layers 23 and mixed conductor layers 21; and
E. The layers are combination of superconductor layers 22, normal metal layers 23 and mixed conductor layers 21.

The mixed conductor layers 21 are made of the superconductor tapes 211 and normal metal tapes 212 by arranging and winding alternately.

The numbers of the mixed conductor layers 21, superconductor layers 22, or normal metal conductor layer 23 can vary in the range from 1 to 20 according to designed current carrying capacity of the cable. The number of different layers is shown by partially taken-away views in the drawings.

As illustrated in FIG. 5, the cross sectional shapes of the superconductor tapes 211 and the normal metal tapes 212 can be rectangle, square, circle, ellipse or flat ellipse. The material of the metal tapes 212 can be selected from copper, aluminum, silver or their alloy.

FIG. 2 is a perspective schematic view of a hybrid superconductor cable in according with the present invention, in which the conductor unit formed completely from mixed conductor layers i.e., combined by pattern A. All the layers in the conductor unit are mixed conductor layers 21, which is made of superconductor tapes 211 and normal metal tapes 212 by alternately arranging and winding. The number of layers should be determined in the range of 1 to 20 according to the requirement of design for the cable. FIG. 2 uses cross sectional view partially taken-away to show the number of the layers.

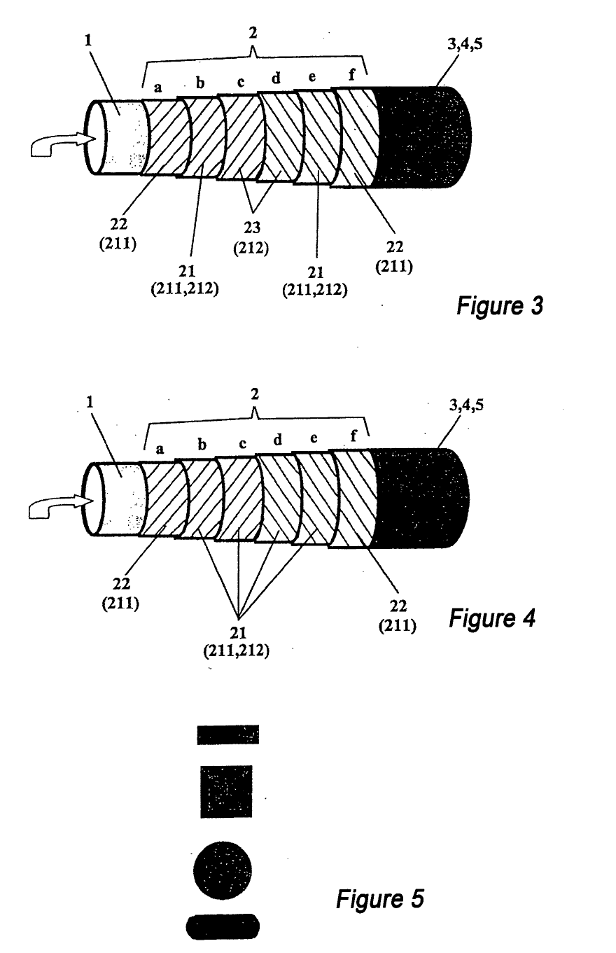

FIG. 3 is a perspective schematic view of a typical embodiment of combination pattern E of a 3-meter hybrid superconductor cable with a multilayer structure. There are 6 conductor layers in the cable conductor 2, numbered from inside to outside with a, b, c, d, e, f. The experimental results show that the layers a and f carry largest currents, layers b and e carry moderate currents, while layers c and d load the smallest currents. That is why the layers a and f are superconductor layers 22 made of superconductor tapes 211, the layers b and e are mixed conductor layers 21 made of superconductor tapes 211 and normal metal tapes 212, and layers c and d are normal metal conductor layers 23 made of normal metal conductor tapes 212.

Winding parameters of 3-m hybrid
superconducting cable

| | | Layer 2 | | | | Layer 5 | | | Total |
|---|---|---|---|---|---|---|---|---|---|
| Tape | Layer 1 | 17 | | Layer 3 | Layer 4 | 18 | | Layer 6 | S48 |
| number | S15* | S8 | M9* | M20 | M20 | S9 | M9 | S16 | M58 |

| | | | | | | |
|---|---|---|---|---|---|---|
| Winding | + | + | + | □ | □ | □ |
| direction | | | | | | |
| (+ −)* | | | | | | |
| Helix | 37.7 | 25.5 | 7.0 | −13.1 | −30.2 | −44.6 |
| angle for | | | | | | |
| winding | | | | | | |
| (°) | | | | | | |
| Pitch | 105.7 | 177.8 | 716.4 | 391.5 | 161.9 | 98.8 |
| (mm) | | | | | | |
| Layer | 13 | 13.5 | 14 | 14.5 | 15 | 15.5 |
| radius | | | | | | |
| (mm) | | | | | | |

| | |
|---|---|
| outside | 25.8 |
| diameter | |
| of cable | |
| frame | |
| (mm) | |

*S15 means superconductor tapes 15
*M9 means normal metal tapes 9
*+ means winding in direction of clockwise
*− means winding in direction of anti-clockwise

Table above shows that for same current carrying capacity, with the present invention, one can substitutes 58 superconductor tapes with normal metal tapes, thus saves expensive superconductor tapes, reduces the manufacturing cost, and enhances the mechanic strength and the ability to resist quench.

FIG. 4 shows another perspective structural schematic view of a hybrid superconductor cable in accordance with a typical embodiment of combination pattern C of the present invention. Wherein the cable conductor unit are composed of 6 layers numbered from inside to outside with a, b, c, d, e, f, with the same multilayer-like cable structure shown in FIG. 3. However, the pattern the layers are combined by is different. Layers a and f are superconductor layers 22, made of superconductor tapes 211. Layers b, c, d and e are mixed conductor layers 21, made of superconductor tapes and normal metal tapes.

Of course, other combination patterns of the hybrid superconductor cable can also be put forward as examples. In combination pattern B, the cable conductor unit 2 is made by combining the superconductor layers 22 with the normal metal conductor layer 23. In combination pattern D, the cable conductor unit 2 is made by combining the mixed conductor layers 21 with the normal metal conductor layers 23. Since the detail structures have been shown in FIG. 1 and FIG. 3, we will not have more explanations here.

To summary, compared with present superconductor cables, no matter what kind of combination style the cable conductor unit 2 uses, for the same power transmission capacity, the hybrid superconductor cable simplifies the fabrication technique, reduces the cost, enhances the mechanic strength and the ability to resist quench, thus it should lay a foundation for the industrialization of superconductor cables.

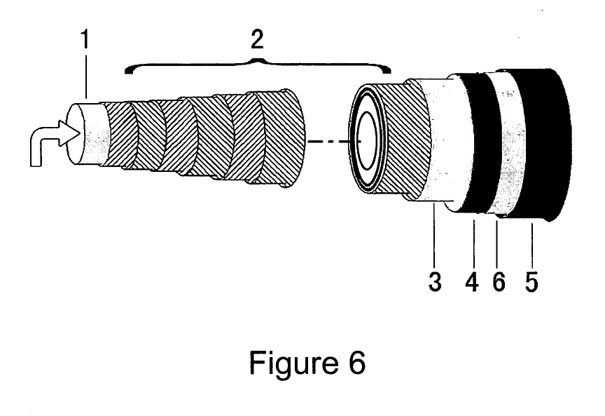

FIG. 6 is a perspective schematic view of a hybrid superconductor cable in according with another embodiment of the present invention showing out multilayer structure thereof. As shown in FIG. 6, the hybrid superconducting cable is different form the first embodiment in that it further comprises a dielectric layer 6 in addition to the cable former 1, the conductor unit 2, the adiabatic envelope 3, the screening layer 4 and the protective encloser 5.

Although the present invention has been described and illustrated in detail, it is clearly understood that the same is by way of illustration and example only and is not to be taken by way of limitation, the spirit and scope of the present invention being limited only by the terms of the appended claims.

1. A hybrid superconducting cable comprising a cable former, a conductor unit, an adiabatic envelope, a screening layer, and a protective encloser, characterized in that the conductor unit is a hybrid conductor unit formed from mixed conductors or a combination of superconductor layers, normal metal conductor layers, and mixed conductor layers.

2. The hybrid superconducting cable as described in claim 1, further comprising a dielectric layer.

3. The hybrid superconducting cable as described in claim 1, wherein the pattern by which the layers in the hybrid conductor unit are combined is selected from a group consisting of the followings:
A. all the layers are mixed conductor layers;
B. the layers are combination of superconductor layers and normal metal conductor layers;
C. the layers are combination of superconductor layers and mixed conductor layers;
D. the layers are combination of normal metal conductor layers and mixed conductor layers; and
E. the layers are combination of superconductor layers, normal metal conductor layers, and mixed conductor layers.

4. The hybrid superconducting cable as described in claim 1, wherein the mixed conductor layers are made of superconductor tapes and normal metal tapes by alternatively arranging and winding.

5. The hybrid superconducting cable as described in claim 1, wherein the numbers of the superconductor layers, the normal metal conductor layers and the mixed conductor layers are respectively in the range of 1 to 20.

6. The hybrid superconducting cable as described in claim 3, wherein the cross-sectional shapes of the superconductor tapes and the normal metal tapes are rectangle, square, circle, ellipse or flat ellipse.

7. The hybrid superconducting cable as described in claim 3, wherein the material of the normal metal tapes is selected from a group consisting of copper, aluminum, silver and their alloys.
